(19) United States
(12) Patent Application Publication
(10) Pub. No.: US 2014/0272529 A1
(43) Pub. Date: Sep. 18, 2014

(54) MANUFACTURING TECHNIQUES USING UNIFORM PRESSURE TO FORM THREE-DIMENSIONAL STACKED-CELL BATTERIES

(71) Applicant: Apple Inc., Cupertino, CA (US)

(72) Inventors: Sheba Devan, Santa Clara, CA (US); Richard M. Mank, Los Altos, CA (US); George V. Anastas, San Carlos, CA (US); Jack B. Rector, III, San Ramon, CA (US); Qingcheng Zeng, Cupertino, CA (US); Shouwei Hao, Gilroy, CA (US); Adnan N. Jafri, Milpitas, CA (US)

(73) Assignee: Apple Inc., Cupertino, CA (US)

(21) Appl. No.: 14/207,061

(22) Filed: Mar. 12, 2014

Related U.S. Application Data
(60) Provisional application No. 61/792,253, filed on Mar. 15, 2013.

(51) Int. Cl. H01M 10/0585

(52) U.S. Cl. CPC H01M 10/0585
USPC 429/144; 429/152; 156/306.3; 156/285; 156/581

(57) ABSTRACT

The disclosed embodiments relate to the manufacture of a battery cell. The battery cell includes a first set of layers including a cathode with an active coating, a separator, and an anode with an active coating. The separator may include a ceramic coating and a binder coating over the ceramic coating. During manufacturing of the battery cell, the layers are stacked, and the binder coating is used to laminate the first set of layers within the first sub-cell by applying at least one of pressure and temperature to the first set of layers. In addition, uniform pressure is applied to the cell stack to laminate the first and second sets of layers.

### RELATED APPLICATION

This application claims the benefit of U.S. Provisional Application No. 61/792,253, Attorney Docket Number APL-P19023USP1, entitled “Manufacturing Techniques for Three-Dimensional Stacked-Cell Batteries,” by inventors Sheba Devan, Richard M. Mank, George V. Anastas, Jack B. Rector III, Qingcheng Zeng, Shouwei Hao and Adnan N. Jafri, filed 15 Mar. 2013, which is incorporated herein by reference.

The subject matter of this application is related to the subject matter in a co-pending non-provisional application by the same inventors as the instant application and filed on the same day as the instant application entitled “Manufacturing Technique Using Binder Coatings in Three-Dimensional Stacked-Cell Batteries,” having serial number TO BE ASSIGNED, and filing date TO BE ASSIGNED (Attorney Docket No. APL-P19023US1).

The subject matter of this application is also related to the subject matter in a co-pending non-provisional application by the same inventors as the instant application and filed on the same day as the instant application entitled “Manufacturing Technique Using Fiducials in Three-Dimensional Stacked-Cell Batteries,” having serial number TO BE ASSIGNED, and filing date TO BE ASSIGNED (Attorney Docket No. APL-P19023US3).

### BACKGROUND

1. Field

The disclosed embodiments relate to batteries for portable electronic devices. More specifically, the disclosed embodiments relate to techniques for manufacturing three-dimensional stacked-cell batteries for portable electronic devices.

2. Related Art

Rechargeable batteries are presently used to provide power to a wide variety of portable electronic devices, including laptop computers, tablet computers, mobile phones, personal digital assistants (PDAs), digital music players and cordless power tools. The most commonly used type of rechargeable battery is a lithium battery, which can include a lithium-ion or a lithium-polymer battery.

Lithium-polymer batteries typically include cells that are packaged in flexible pouches. Such pouches are typically lightweight and inexpensive to manufacture. Moreover, these pouches may be tailored to various cell dimensions, allowing lithium-polymer batteries to be used in space-constrained portable electronic devices such as mobile phones, laptop computers, and/or digital cameras. For example, a lithium-polymer battery cell may achieve a packaging efficiency of 90-95% by enclosing rolled electrodes and electrolyte in an aluminized laminated pouch. Multiple pouches may then be placed side-by-side within a portable electronic device and electrically coupled in series and/or in parallel to form a battery for the portable electronic device.

However, efficient use of space may be limited by the use and arrangement of cells in existing battery pack architectures. In particular, battery packs typically contain rectangular cells of the same capacity, size, and dimensions. The physical arrangement of the cells may additionally mirror the electrical configuration of the cells. For example, a common six-cell battery pack may include six lithium-polymer cells of the same size and capacity configured in a two in series, three in parallel (2s3p) configuration. Within such a battery pack, two rows of three cells placed side-by-side may be stacked on top of each other; each row may be electrically coupled in a parallel configuration and the two rows electrically coupled in a series configuration. Consequently, the battery pack may require space in a portable electronic device that is at least the length of each cell, twice the thickness of each cell, and three times the width of each cell.

Moreover, this common type of battery pack design may be unable to utilize free space in the portable electronic device that is outside of a rectangular space reserved for the battery pack. For example, a rectangular battery pack of this type may be unable to efficiently utilize free space that is curved, rounded, and/or irregularly shaped.

Hence, the use of portable electronic devices may be facilitated by improvements related to the packaging efficiency, capacity, form factor, design, and/or manufacturing of battery packs containing lithium-polymer battery cells.

### SUMMARY

The disclosed embodiments relate to the manufacture of a battery cell. The battery cell includes a first set of layers including a cathode with an active coating, a separator, and an anode with an active coating. The separator may include a ceramic coating and a binder coating over the ceramic coating. During manufacturing of the battery cell, the layers are stacked, and the binder coating is used to laminate the first set of layers within the first sub-cell by applying at least one of pressure and temperature to the first set of layers.

In some embodiments, the battery cell also includes a second sub-cell containing a second set of layers with different dimensions from the first set of layers. During manufacturing of the battery cell, the first and second sub-cells are stacked to form a cell stack, and the battery cell is formed by applying at least one of the pressure and the temperature to the cell stack.

In some embodiments, the ceramic coating is disposed on one or both sides of the separator.

In some embodiments, the binder coating is applied using at least one of a spray-coating technique, a dip-coating technique, a coating pattern, and a gravure-coating technique.

In some embodiments, the coating pattern includes at least one of a dot, a line, a wave, and a shape.

In some embodiments, the binder coating includes at least one of polyvinylidene fluoride (PVDF), a PVDF copolymer, and an acrylic.

In some embodiments, the first and second sub-cells include at least one of a mono-cell, a bi-cell, and a half-cell.

In some embodiments, uniform pressure is applied to the cell stack to laminate the first and second sets of layers.

In some embodiments, the uniform pressure is applied to the cell stack using a set of stepped plates.

In some embodiments, the uniform pressure is further applied using a buffer material disposed over one or more of the stepped plates.

In some embodiments, the uniform pressure is further applied using a heat block disposed below the cell stack.

In some embodiments, the uniform pressure is applied to the cell stack using an isostatic-pressing technique.

In some embodiments, the uniform pressure is applied using at least one of a gas, a liquid, and a motor.

In some embodiments, one or more fiducials are disposed on each electrode from a set of electrodes for the battery cell and/or a fixture for the electrodes. The one or more fiducials may be used to align the electrodes during stacking of the set of electrodes.

In some embodiments, the set of fixtures includes at least one of a carrier plate, a carrier film, and an extended separator layer.

In some embodiments, the one or more fiducials are used to inspect an alignment of the stacked set of electrodes in the battery cell.

In some embodiments, the one or more fiducials include a first fiducial and a second fiducial separated from the first fiducial by a distance that enables resolution of alignment errors in the set of electrodes.

In some embodiments, the one or more fiducials are disposed on a current collector of the electrode.

In some embodiments, the one or more fiducials are disposed on the electrode using a laser-cutting technique.

In some embodiments, the one or more fiducials include at least one of a point, a cross, and a position hole.

### BRIEF DESCRIPTION OF THE FIGURES

FIG. 1 shows a battery cell in accordance with the disclosed embodiments.

FIG. 2 shows a set of layers for a battery cell in accordance with the disclosed embodiments.

FIG. 3A shows an exemplary stacking of a set of layers for a battery cell in accordance with the disclosed embodiments.

FIG. 3B shows an exemplary stacking of a set of layers for a battery cell in accordance with the disclosed embodiments.

FIG. 4A shows a cross-sectional view of an apparatus for manufacturing a battery cell in accordance with the disclosed embodiments.

FIG. 4B shows a top-down view of an exemplary layout of a set of stepped plates for manufacturing a battery cell in accordance with the disclosed embodiments.

FIG. 4C shows a top-down view of an exemplary layout of a set of stepped plates for manufacturing a battery cell in accordance with the disclosed embodiments.

FIG. 4D shows a top-down view of an exemplary layout of a set of stepped plates for manufacturing a battery cell in accordance with the disclosed embodiments.

FIG. 5A shows the transport of a set of singulated electrodes for a battery cell in accordance with the disclosed embodiments.

FIG. 5B shows the use of a set of rolls of carrier film by a process associated with manufacturing of a battery cell in accordance with the disclosed embodiments.

FIG. 6 shows a set of fiducials on an electrode for a battery cell in accordance with the disclosed embodiments.

FIG. 7 shows a set of fiducials on a fixture for an electrode of a battery cell in accordance with the disclosed embodiments.

FIG. 8 shows the formation of a set of layers of separator for a battery cell in accordance with the disclosed embodiments.

FIG. 9 shows a flowchart illustrating the process of manufacturing a battery cell in accordance with the disclosed embodiments.

FIG. 10 shows a flowchart illustrating the process of manufacturing a battery cell in accordance with the disclosed embodiments.

FIG. 11 shows a flowchart illustrating the process of manufacturing a battery cell in accordance with the disclosed embodiments.

FIG. 12 shows a flowchart illustrating the process of manufacturing a battery cell in accordance with the disclosed embodiments.

FIG. 13 shows a flowchart illustrating the process of manufacturing a battery cell in accordance with the disclosed embodiments.

FIG. 14 shows a portable electronic device in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

FIG. 1 shows a battery cell in accordance with the disclosed embodiments. The battery cell may be a lithium-polymer cell that supplies power to a portable electronic device such as a laptop computer, mobile phone, tablet computer, personal digital assistant (PDA), portable media player, digital camera, and/or other type of battery-powered electronic device.

As shown in FIG. 1, the battery cell includes a number of layers 102-106 that form a non-rectangular, terraced structure with a rounded corner. Layers 102-106 may include a cathode with an active coating, a separator, and an anode with an active coating. For example, each set of layers 102-106 may include one strip of cathode material (e.g., aluminum foil coated with a lithium compound) and one strip of anode material (e.g., copper foil coated with carbon) separated by one strip of separator material (e.g., conducting polymer electrolyte).

To form the non-rectangular shape, layers 102-106 may be cut from sheets of cathode, anode, and/or separator material. For example, layers 102-106 may be formed by cutting substantially rectangular shapes with rounded upper right corners from the sheets of material. Moreover, the sheets of material may be cut so that layers 102-106 have the same shape but the bottommost layers 102 are the largest, the middle layers 104 are smaller, and the topmost layers 106 are the smallest.

Layers 102-106 may then be arranged to form the non-rectangular shape. For example, layers 102-106 may be formed into sub-cells of different sizes that are stacked to create the non-rectangular shape. Each sub-cell may be a mono-cell containing an anode layer, a cathode layer, and one or more separator layers; a bi-cell containing multiple anode and/or cathode layers with layers of separator sandwiched between the anode and cathode layers; and/or a half-cell containing a separator layer and either an anode or a cathode layer.

After layers 102-106 are formed into the non-rectangular shape, layers 102-106 may be enclosed in a pouch 108, and a set of conductive tabs 110-112 may be extended through seals in the pouch (for example, formed using sealing tape) to provide terminals for the battery cell. Conductive tabs 110-112 may be used to electrically couple the battery cell with one or more other battery cells to form a battery pack. For example, conductive tab 110 may be coupled to the cathode(s) of layers 102-106, and conductive tab 112 may be coupled to the anode(s) of layers 102-106. Conductive tabs 110-112 may further be coupled to other battery cells in a series, parallel, or series-and-parallel configuration to form the battery pack. The coupled cells may be enclosed in a hard case to complete the battery pack, or the coupled cells may be embedded within the enclosure of the portable electronic device.

To enclose the battery cell in pouch 108, layers 102-106 may be placed on top of a flexible sheet made of aluminum with a polymer film, such as polypropylene. Another flexible sheet may then be placed over the tops of layers 102-106, and the two sheets may be heat-sealed and/or folded. Alternatively, layers 102-106 may be placed in between two sheets of pouch material that are sealed and/or folded on some (e.g., non-terminal) sides. The remaining sides(s) may then be heat-sealed and/or folded to enclose layers 102-106 within pouch 108.

In one or more embodiments, the battery cell of FIG. 1 facilitates efficient use of space within the portable electronic device. For example, the terraced and/or rounded edges of the battery cell may allow the battery cell to fit within a curved enclosure for the portable electronic device. The number of layers (e.g., layers 102-106) may also be increased or decreased to better fit the curvature of the portable electronic device's enclosure. In other words, the battery cell may include an asymmetric and/or non-rectangular design that accommodates the shape of the portable electronic device. In turn, the battery cell may provide greater capacity, packaging efficiency, and/or voltage than rectangular battery cells in the same portable electronic device.

To facilitate the use of a stacked-cell design in the battery cell, a number of techniques may be used in the manufacturing of the battery cell. The techniques may include the use of a binder coating to form the battery cell from multiple disparate stacks of layers (e.g., layers 102-106), as discussed in further detail below with respect to FIG. 2. To increase the stiffness of the battery cell and/or adhesion of layers within the battery cell, uniform pressure may be applied to the stacks, as described in further detail below with respect to FIGS. 3A-3B and 4A-4B.

To protect the layers during transport between different manufacturing processes, singulated electrodes for the battery cell may be placed in a roll of carrier film, as discussed in further detail below with respect to FIGS. 5A-5B. Fiducials may also be placed on the layers and/or fixtures for the layers to accurately stack the electrodes, as discussed in further detail below with respect to FIGS. 6-7. Finally, precise laser cutting of separator layers may be facilitated by simultaneously cutting two or more sides of a shape from a sheet of separator material orthogonally to the direction of tension applied to the sheet, as discussed in further detail below with respect to FIG. 8.

FIG. 2 shows a set of layers for a battery cell in accordance with the disclosed embodiments. The layers may include a cathode current collector 202, cathode active coating 204, separator 206, anode active coating 208, and anode current collector 210. The layers may be stacked to form a three-dimensional battery cell such as the battery cell of FIG. 1.

As mentioned above, cathode current collector 202 may be aluminum foil, cathode active coating 204 may be a lithium compound (e.g., LiCoO₂, LiNCoMn, LiCoAl, LiMn₂O₄), anode current collector 210 may be copper foil, anode active coating 208 may be carbon, and separator 206 may include polypropylene and/or polyethylene.

Separator 206 may additionally be a coated separator that includes a micro-alumina (AL₂O₃) and/or other ceramic coating, which can be single-sided or double-sided. This alumina coating is advantageous because it provides the mechanical ruggedness of the alumina, which is about as tough as the LiCoO₂ particles themselves. Moreover, the additional ruggedness provided by the alumina layer may prevent a particle of LiCoO₂ from working its way through separator 206, which can potentially cause a shunt. As a result, the ceramic coating may promote temperature stability in the battery cell and mitigate faults caused by mechanical stress, penetration, puncture, and/or electrical shorts.

The layers may also include a binder coating 212 between the coated separator 206 and cathode active coating 204 and/or anode active coating 208. For example, a composite separator for the battery cell may be created by disposing the ceramic coating over one or both sides of separator 206, then disposing binder coating 212 over the ceramic coating and/or any side of separator 206 that is not covered by the ceramic coating. Binder coating 212 may include polyvinylidene fluoride (PVDF), copolymers of PVDF (e.g., poly(vinylidene fluoride-co-hexafluoropropylene) (PVDF-HFP)), an acrylic (e.g., acrylonitrile), and/or another binder material. Binder coating 212 may be approximately 1 micron thick to facilitate optimal laminating of the layers without degrading the cycle life of the battery cell and/or causing binder coating 212 to flow during exposure to heat.

In addition, binder coating 212 may be a continuous coating and/or non-continuous coating. For example, binder coating 212 may be applied as a continuous coating on separator 206 using a dip-coating technique. On the other hand, binder coating 212 may be applied as a non-continuous coating on cathode active coating 204, separator 206, and/or anode active coating 208 using a spray-coating technique, a gravure-coating technique, and/or a coating pattern such as a series of dots, lines, waves, and/or shapes.

Those skilled in the art will appreciate that the ceramic coating and/or binder coating 212 may be applied to separator 206 in other ways. For example, separator 206 may include a first side with a ceramic coating and a second side with binder coating 212. Alternatively, two layers of separator 206 may be used, with the first layer coated on both sides with the ceramic coating and the second layer coated on both sides with binder coating 212. The ceramic coating may promote temperature stability and/or mitigate faults caused by mechanical stress, penetration, puncture, and/or electrical shorts, while binder coating 212 may adhere separator 206 to the electrode facing binder coating 212 after pressure and/or temperature are applied to the battery cell.

During manufacturing of the battery cell, the layers may be stacked to form a sub-cell, such as a mono-cell, bi-cell, and/or half-cell. Binder coating 212 may then be used to laminate the layers within the sub-cell by applying pressure and/or temperature to the layers. For example, a pressure of at least 0.13 kgf per square millimeter and a temperature of about 85° C. may be applied to the layers for six to eight hours to melt binder coating 212 and laminate and/or bond the layers together, creating a solid, compressed structure instead of a set of loosely stacked, unbonded layers.

Because binder coating 212 facilitates adhesion among the layers, the amount of pressure, temperature, and/or time required to form a solid, compressed cell stack from the layers may be reduced. Binder coating 212 may additionally maintain alignment of the layers during formation of the cell stack. For example, the cell stack may be created by stacking individual layers of electrodes (e.g., cathode or anode) pre-laminated with separator on top of one another. To add a new layer to the cell stack, a pattern of binder coating 212 (e.g., a series of dots) may be placed on the topmost layer of the cell stack, and the new layer may be placed over the topmost layer and binder coating 212 with a small amount of pressure. The pressure and binder coating 212 may cause the new layer to adhere to the topmost layer, thus preserving the alignment of the new layer in the cell stack as subsequent layers are added to the cell stack.

In addition, the battery cell may be formed from multiple stacked sub-cells in a variety of ways. As shown in FIG. 3A, a set of layers 302 may be stacked and formed into a battery cell by applying pressure 304-310 along the tops and bottoms of layers 302. In addition, pressure 304-310 may be applied uniformly across the battery cell, as described in further detail below with respect to FIGS. 4A-4B.

Portions of the battery cell may also be pressed individually prior to forming the battery cell. As shown in FIG. 3B, pressure 318-320 and/or temperature may be applied to the top and bottom of a first set of layers 312 for the battery cell, and pressure 322-324 and/or temperature may also be applied to a second set of layers 314 independently of pressure 318-320 applied to layers 312. Each set of layers 312-314 may include one or more sub-cells of the same size and/or dimensions. On the other hand, layers 312 may be smaller than layers 314. For example, layers 312 may be cut from sheets of cathode, anode, and/or separator material using one template, and layers 314 may be cut from the sheets using a different, larger template.

After pressure 318-324 and/or temperature are independently applied to each set of layers 312-314, the set of layers 312-314 may be bonded together. Both sets of layers 312-314 may then be stacked to form layers 316, and pressure 326-328 and/or temperature may be applied to layers 316 to bond layers 316 and form a cell stack for the battery cell.

The separate bonding of individual sets of layers 312-314 of different dimensions prior to stacking and bonding both sets of layers 312-314 may facilitate accurate alignment and/or transfer of layers 312-314 during manufacturing of the battery cell. For example, the identical dimensions within each set of layers 312-314 may enable precise alignment of the set of layers prior to bonding the set of layers. Each set of layers 312-314 may then be individually manipulated and/or aligned to facilitate the creation of a single set of bonded layers 316 in the battery cell. Finally, the holding of layers 316 together by binder coating may mitigate and/or prevent damage to and/or misalignment of layers 316 during subsequent transport, rotation, and/or flipping of layers 316 (e.g., during sealing of layers 316 in a pouch) in the manufacturing process for the battery cell.

FIG. 4A shows a cross-sectional view of an apparatus for manufacturing a battery cell in accordance with the disclosed embodiments. Similarly, FIGS. 4B-4D show top-down views of exemplary layouts of stepped plates 402-406 for manufacturing a battery cell in accordance with the disclosed embodiments. Each set of stepped plates 402-406 may be used to apply pressure and/or temperature to a cell stack 420 of a battery cell, such as the battery cell of FIG. 1. For example, cell stack 420 may include three sets of layers, each with different dimensions, that are stacked to form a battery cell with a terraced, non-rectangular shape. Each level of the terraced shape may be represented by and/or formed using a different stepped plate 402-406 in the apparatus.

As described above, the pressure and/or temperature may laminate the layers of the cell stack together and form interfaces among the cathode, anode, and separator layers that increase the rigidity of the battery cell and/or the resistance of the battery cell to mechanical stress. In addition, uniform application of pressure and/or temperature to the layers may increase the mechanical strength and impact resistance of the cell stack and/or reduce variations in the thicknesses of different cell stacks and/or sub-cells in the cell stacks.

More specifically, a pressing mechanism may be used to apply four pressures P1, P2, P3, and P4 to the cell stack. P1, P2, and P4 may be applied using three load cells 410, 412, and 414, respectively. P1 may be transferred to cell stack 420 through a heat block 408 located below load cell 410 and in contact with one side (e.g., the bottom) of cell stack 420.

On the other hand, P3 may be applied directly to stepped plate 406 in contact with a portion of cell stack 420. Stepped plate 406 may also be used as a heat block to transfer temperature to cell stack 420 during lamination of the layers by the apparatus.

P2 and P4 may be transferred to portions of cell stack 420 not in contact with stepped plate 406 using stepped plates 402-404 and buffer material 416-418 (e.g., urethane pads) disposed between stepped plates 402-404 and load cells 412-414. As with stepped plate 406, stepped plates 402-404 may be used as heat blocks that also transfer temperature to cell stack 420 during lamination of the layers by the apparatus. In addition, linear bearings 422-424 may be disposed between adjoining stepped plates 402-406 to facilitate independent vertical movement of stepped plates 402-406 during application of pressures P1-P4.

Consequently, load cells 410-414, heat block 408, stepped plates 402-406, buffer material 416-418, linear bearings 422-424, and pressures P1-P4 may be used to apply uniform pressure across cell stack 420. For example, P1 and P2 may be controlled to have the same value, and P3 and P4 may be adjusted in a feedback loop to maintain constant, uniform pressure on cell stack 420. As a result, P3 and P4 may be increased to accommodate larger proportions of cell stack 420 under stepped plates 402-404 and decreased to accommodate smaller proportions of cell stack 420 under stepped plates 402-404. Buffer material 416-418 may also absorb variations in pressure between stepped plates 402-406 and heat block 408.

Those skilled in the art will appreciate that a number of techniques may be used to apply uniform pressure to cell stack 420. For example, the pressing mechanism may use a gas, liquid, and/or motor to apply pressures P1, P2, P3, and P4 to cell stack 420. Alternatively, an isostatic-pressing technique may utilize a liquid or gas pressurizing medium to apply a uniform pressure throughout cell stack 420 sealed within a flexible membrane and/or hermetic container.

FIG. 5A shows the transport of a set of singulated electrodes 506-512 for a battery cell (e.g., the battery cell of FIG. 1) in accordance with the disclosed embodiments. Electrodes 506-512 may be singulated from a sheet 502 of electrode material. For example, sheet 502 may include a portion of exposed electrode substrate (e.g., copper or aluminum), including a conductive tab for the electrode, and a portion of electrode substrate coated with active material (e.g., carbon or lithium). Electrodes 506-512 may be created by laser-cutting shapes corresponding to electrodes 506-512 from the coated portion of sheet 502 and laser-cutting shapes corresponding to tabs for electrodes 506-512 from the non-coated portion of sheet 502. Electrodes 506-512 may then be used to form non-rectangular, three-dimensional stacked-cell batteries.

After electrodes 506-512 are cut from sheet 502, any burrs and/or hardened edges on electrodes 506-512 may be treated by a second laser of a different wavelength and/or energy level than the laser used to cut electrodes 506-512. The clean edge produced by the second laser on each electrode 506-512 may facilitate precise stacking and/or compressing of electrodes 506-512 in the battery cell.

To facilitate transport of electrodes 506-512 after singulation, electrodes 506-512 are disposed over a first layer of carrier film 514, which is then formed into a roll 504. A second layer of carrier film may also be disposed over electrodes 506-512 to sandwich and/or seal electrodes 506-512 between the two layers of carrier film and further protect electrodes 506-512 from damage. Roll 504 may then be transported to a subsequent process associated with manufacturing of the battery cell.

For example, electrodes 506-512 may be stacked over other electrodes and/or separator material of the same dimensions to form sub-cells (e.g., mono-cells, half-cells, bi-cells) for the battery cell. The sub-cells may be evenly spaced over and/or under one or more layers of polyethylene terephthalate (PET), mylar, polyethylene, polypropylene, and/or other types of carrier film 514. Frictional force between the sub-cells and carrier film 514 and/or tension in carrier film 514 may facilitate adherence of the sub-cells to carrier film 514.

Carrier film 514 may then be wound into a roll 504 that is transported to a process for stacking and/or bonding of electrodes 506-512. Because electrodes 506-512 are enveloped on all sides by carrier film 514, carrier film 514 may prevent damage to the edges of electrodes 506-512 that may occur with use of conventional mechanisms for transporting electrodes 506-512, such as trays and/or cartridges.

To further facilitate safe transport of electrodes 506-512, one or more layers of carrier film 514 may include depressions for accommodating electrodes 506-512. For example, the bottom layer of carrier film 514 may have electrode-shaped indentations into which electrodes 506-512 are placed. A top layer of carrier film 514 may then be disposed over the bottom layer, and the edges of carrier film 514 surrounding electrodes 506-512 may be sealed. Tooling holes may also be added to carrier film 514 for use by the subsequent process. For example, the tooling holes may enable the accurate location of evenly spaced electrodes 506-512 in roll 504 by the subsequent process.

FIG. 5B shows the use of a set of rolls 520-524 of carrier film by a process 526 associated with manufacturing of a battery cell in accordance with the disclosed embodiments. As shown in FIG. 5B, rolls 520-524 may be fed into process 526 to create a set of sub-cells 528-532 of the battery cell. For example, rolls 520-524 may be used to safely transport singulated electrodes and/or layers of the battery cell to process 526, as described above with respect to FIG. 5A. Roll 520 may contain singulated cathodes, roll 522 may contain singulated separators, and roll 524 may contain singulated anodes.

Prior to forming sub-cells 528-532, rolls 520-524 may be loaded and unwound by process 526. If a top layer of carrier film is disposed over one or more rolls 520-524, the top layer may be removed during unwinding to enable use of the singulated layers sandwiched between the top layer and a bottom layer of carrier film in the roll(s) by process 526.

After segments of rolls 520-524 are unwound and fed into process 526, the singulated layers in the segments may be used to form sub-cells 528-532. For example, process 526 may be a “pick-and-place” process that picks singulated cathode, separator, and anode layers from rolls 520-524 and arranges (e.g., places) the picked layers in stacked sub-cells 528-532. Tooling holes in rolls 520-524 may allow process 526 to accurately locate the singulated layers in each roll. Process 526 may also press sub-cells 528-532 before sub-cells are conveyed for additional stacking and/or pressing to form a cell stack for the battery cell, as described above.

FIG. 6 shows a set of fiducials on an electrode 602 for a battery cell in accordance with the disclosed embodiments. As shown in FIG. 6, the fiducials may include a set of crosses 606-608, a point 610, and/or a position hole 612. The fiducials may be formed in electrode 602 and/or a tab 604 for electrode 602 using a cutting technique, a pressing technique, and/or an ablation technique. For example, a laser-cutting technique may be used to form one or more points (e.g., point 610) and/or a series of unconnected points and/or other shapes that form a cross (e.g., crosses 606-608) in electrode 602 and/or tab 604.

The fiducials may be used to stack electrode 602 and/or other electrodes in the battery cell. For example, crosses 606-608 may be used to align electrode 602 with one or more other electrodes along two dimensions, point 610 may provide a reference for rotation of electrode 602, and position hole 612 may be used with a locating pin that aligns position hole 612 with position holes in other layers of the battery cell. Position hole 612 may optionally be removed after the layers are stacked and/or bonded together.

The fiducials of FIG. 6 may facilitate precise alignment of the layers within a three-dimensional battery cell. For example, crosses 606-608, point 610, and/or position hole 612 may allow electrodes and/or other layers of the battery cell of different sizes, shapes, and/or dimensions to be stacked in a way that forms a desired shape for the battery cell in the absence of a guide rail and/or shared edge in the layers. Two or more fiducials may be placed at pre-specified distances from one another on electrode 602 and/or tab 604 to reduce both positional and rotational displacement among electrode 602 and/or other layers in the battery cell. For example, two points on electrode 602 and/or tab 604 may be separated by a distance that enables resolution of alignment errors in the layers. A greater distance may increase such resolution of alignment errors, while a smaller distance may decrease the resolution of alignment errors.

More specifically, a pick-and-place process may be used to stack electrode 602 and other layers to form one or more sub-cells and/or a cell stack for the battery cell. During the pick-and-place technique, electrode 602 may be picked up from a feeding mechanism such as a roll of carrier film and/or a feeder tray by a robotic arm. An image of electrode 602 in the robotic arm may be captured from above and/or below the robotic arm, and fiducials in the image may be used to correct the position and/or orientation of the robotic arm prior to placing electrode 602 on top of a fixture and/or another electrode.

Crosses 606-608, point 610, and/or position hole 612 may thus provide a fixed frame of reference that improves the accuracy of placement of electrode 602 on the sub-cell over a geometry-based frame of reference used to place an electrode that does not contain fiducials. The improved accuracy may further tighten position and/or size tolerances in the battery cell and allow for an increase in the energy density of the battery cell. For example, the tightened registration enabled by fiducials on electrode 602 and/or other electrodes may improve the packaging efficiency of the battery cell and allow additional active material to be included along the periphery of electrodes in the battery cell, thus increasing the energy density of the battery cell.

Fiducials in electrode 602 and/or other electrodes may additionally be used during final inspection of an assembled battery cell. For example, fiducials may be placed in exposed current collectors of the electrodes (e.g., along the edges and/or on the tabs of the electrodes) to provide features that can be detected using x-ray. In turn, the features may be used in an x-ray inspection of a battery cell sealed in a pouch to inspect the alignment of the stacked layers in the battery cell and verify that internal geometries in the assembled battery cell meet requirements (e.g., one or more sets of fiducials are aligned within a pre-specified radius across all layers of the battery cell).

In other words, a precise three-dimensional shape and/or contour may be formed in the battery cell by stacking and/or aligning the layers according to the fiducials. An increase in the number of fiducials in electrode 602 and/or tab 604 may improve the alignment accuracy of the layers, while a decrease in the number of fiducials in electrode 602 and/or tab 604 may reduce overhead associated with manufacturing of the layers and/or the battery cell and/or the overall capacity of the battery cell (e.g., if active material is removed to form the fiducials).

FIG. 7 shows a set of fiducials on a fixture 704 for an electrode 702 of a battery cell in accordance with the disclosed embodiments. As with the fiducials of FIG. 6, the fiducials of FIG. 7 may include one or more crosses 706-708, one or more position holes 710-712, and/or one or more points (not shown). The fiducials may be cut, pressed, and/or ablated from fixture 704.

Fixture 704 may be a carrier plate, carrier film (e.g., carrier film 514 of FIG. 5), extended separator layer, and/or other mechanism for transporting, supporting, and/or mounting electrode 702. As a result, the fiducials of FIG. 7 may be used to position and/or stack electrode 702 and/or other electrodes on fixture 704, in lieu of and/or in addition to the fiducials of FIG. 6.

For example, fiducials may be present on both the carrier plate and carrier film. To align electrode 702 with other electrodes in the battery cell, the carrier film may be positioned over the carrier plate, with crosses 706-708 aligned on top of one another and/or position holes 710-712 in the carrier film placed over corresponding locating pins in the carrier plate. The carrier film may then be removed from electrode 702 after alignment is complete (e.g., using a vacuum and/or by bonding electrode 702 to other layers of the battery cell) to stack electrode 702 over the other electrodes.

In another example, fixture 704 may be a long, continuous separator to which fixture 704 is bonded and/or pre-laminated. To facilitate subsequent cutting and/or stacking of the bonded electrode 702 and fixture 704, fiducials may be placed at pre-specified locations on fixture 704 relative to electrode 702. The fiducials may subsequently be used to identify the edges of electrode 702, cut electrode 702 out of the long, continuous separator, and/or stack electrode 702 over other layers of the battery cell.

FIG. 8 shows the formation of a set of layers of separator for a battery cell in accordance with the disclosed embodiments. Layers 822-826 may be cut from a sheet of separator material, such as polypropylene and/or polyethylene coated with a ceramic coating and/or binder coating. During cutting of layers 822-826, tension 818-820 may be maintained along a length of the sheet, and a rounded corner may be formed in each layer 822-826 by laser-cutting a shape from the sheet.

However, tension 818-820 may prevent a precise shape from being cut from the sheet. For example, the straight side of the shape may be cut from the sheet, followed by the curved side. The release of tension 818-820 following cutting of the straight side may deform and/or tear the sheet and prevent precise cutting of the curved side from the sheet.

To facilitate precise cutting of layers 822-826 from the sheet, both sides of the shape may be cut simultaneously and orthogonally to the direction of tension 818-820. For example, a laser may initially cut at a point 802 along the straight side in the sheet, then a point 804 at the same vertical position along the curved side in the sheet. The laser may proceed to a point 806 to the right of point 802 on the straight side, then to a point 808 to the right of point 804 on the curved side. The laser may continue cutting to a point 810 to the right of point 808 on the curved side, then to a point 812 to the right of point 806 on the straight side. Finally, the laser may cut both sides of the shape to a common point 814 at which the sides converge. By cutting both sides orthogonally to the direction of tension 818-820 at the same rate, the laser may maintain precise cutting positions on the sheet, thus enabling the consistent creation of layers 822-826 from the sheet.

FIG. 9 shows a flowchart illustrating the process of manufacturing a battery cell in accordance with the disclosed embodiments. In one or more embodiments, one or more of the steps may be omitted, repeated, and/or performed in a different order. Accordingly, the specific arrangement of steps shown in FIG. 9 should not be construed as limiting the scope of the embodiments.

Initially, a set of layers for a battery cell is obtained (operation 902). The layers may include a cathode with an active coating, a separator, and an anode with an active coating. Next, a coated separator is formed by applying a ceramic coating to the separator (operation 904). For example, the coated separator may be formed by depositing an alumina coating on one or both sides of the separator. A binder coating is also applied to the coated separator (operation 906). For example, the binder coating may include PVDF, a PVDF copolymer, and/or an acrylic that is applied to the coated separator using a spray-coating technique, a dip-coating technique, a coating pattern, and/or a gravure-coating technique. The coating pattern may include lines, dots, waves, and/or shapes. In other words, the coated separator may include a first ceramic coating over a separator and a second binder coating over the ceramic coating.

The set of layers is then stacked to form a sub-cell (e.g., mono-cell, bi-cell, half-cell) of the battery cell (operation 908), and the binder coating is used to laminate the set of layers within the sub-cell by applying pressure and/or temperature to the set of layers (operation 910). The application of pressure and/or temperature may melt the binder coating and cause the layers to bond together.

Additional sub-cells may also be formed (operation 912) in the battery cell. If additional sub-cells are to be formed, layers for the sub-cells are obtained (operation 902), and the separator from the layers is coated with a ceramic coating (operation 904) and binder coating (operation 906). The layers are then stacked to form the sub-cells (operation 908), and the binder coating is used to laminate the set of layers within the sub-cells (operation 910).

After all sub-cells have been formed, the sub-cells are stacked to form a cell stack (operation 914), and the battery cell is formed by applying uniform pressure and/or temperature to the cell stack (operation 916). The uniform pressure may be applied using a set of stepped plates, a buffer material disposed over one or more of the stepped plates, and/or a motor. Alternatively, the uniform pressure may be applied using an isostatic-pressing technique that utilizes a membrane or hermetic chamber and a liquid- or gas-pressing mechanism. The stacked and/or bonded sub-cells may form a solid structure that maintains alignment of the layers and/or sub-cells while the sub-cells are moved, rotated, flipped, and/or otherwise manipulated during subsequent manufacturing of the battery cell.

FIG. 10 shows a flowchart illustrating the process of manufacturing a battery cell in accordance with the disclosed embodiments. In one or more embodiments, one or more of the steps may be omitted, repeated, and/or performed in a different order. Accordingly, the specific arrangement of steps shown in FIG. 10 should not be construed as limiting the scope of the embodiments.

First, a set of electrodes for a battery cell is singulated from a sheet of electrode material (operation 1002). For example, a laser-cutting technique may be used to form electrodes for a three-dimensional battery cell from a sheet of cathode and/or anode material. Next, the singulated electrodes are disposed over a first layer of carrier film (operation 1004), and a second layer of carrier film is optionally disposed over the singulated electrodes (operation 1006). For example, the singulated electrodes may be sandwiched by two layers of PET, mylar, polyethylene, and/or polypropylene film after the singulated electrodes are laser-cut.

A set of fiducials is also disposed on the carrier film (operation 1008), and the carrier film is formed into a roll (operation 1010). The roll may facilitate transport of the electrodes to a subsequent process associated with manufacturing of the battery cell. For example, the roll may protect the edges of the electrodes from damage during transport of the electrodes.

Finally, the fiducials on the carrier film are used to stack the electrodes (operation 1012). For example, the carrier film may be unwound, the fiducials on the carrier film may be aligned with fiducials on a fixture for the electrodes, and the carrier film may be removed to deposit an electrode on a stack of electrodes for the battery cell.

FIG. 11 shows a flowchart illustrating the process of manufacturing a battery cell in accordance with the disclosed embodiments. In one or more embodiments, one or more of the steps may be omitted, repeated, and/or performed in a different order. Accordingly, the specific arrangement of steps shown in FIG. 11 should not be construed as limiting the scope of the embodiments.

Initially, a set of rolls is transported to a process associated with manufacturing of the battery cell (operation 1102). Each roll may include a set of singulated layers of the battery cell disposed over a first layer of carrier film that is formed into the roll, and optionally a second layer of carrier film disposed over the singulated layers to sandwich and/or seal the singulated layers between the two layers of carrier film. The rolls may be used to transport singulated cathodes, anodes, and/or separators to the process.

Next, during unwinding of the rolls at the process, the second layer of carrier film (if present) is removed to enable use of the singulated layers by the process (operation 1104), and the singulated layers are used to form a set of sub-cells for the battery cell (operation 1106). For example, singulated layers from the rolls may be fed into the process, where the layers are stacked and/or bonded to form mono-cells, bi-cells, and/or half-cells.

FIG. 12 shows a flowchart illustrating the process of manufacturing a battery cell in accordance with the disclosed embodiments. In one or more embodiments, one or more of the steps may be omitted, repeated, and/or performed in a different order. Accordingly, the specific arrangement of steps shown in FIG. 12 should not be construed as limiting the scope of the embodiments.

Initially, one or more fiducials are disposed on each electrode from a set of electrodes and/or a fixture for the set of electrodes in the battery cell (operation 1202). The fiducials may include a point, a cross, and/or a position hole. For example, the fiducials may include a first fiducial and a second fiducial separated from the first fiducial by a distance that enables resolution of alignment errors in the set of electrodes. In addition, the fiducials may be disposed on the electrode using a cutting technique, a pressing technique, and/or an ablation technique.

Next, the fiducial(s) are used to align the electrode during stacking of the set of electrodes (operation 1204). For example, the fiducial(s) may serve as references for aligning each electrode on top of other electrodes in the stack and/or pressing or bonding the electrodes together within the stack. Fiducials on the electrodes may also be used to inspect the alignment of the stacked electrodes in the battery cell (operation 1206). For example, a visual and/or x-ray inspection of the battery cell may be conducted to verify that one or more sets of fiducials on all layers of the battery cell are aligned within a pre-specified radius and/or tolerance before the battery cell is further assembled, installed, and/or used in a portable electronic device.

FIG. 13 shows a flowchart illustrating the process of manufacturing a battery cell in accordance with the disclosed embodiments. In one or more embodiments, one or more of the steps may be omitted, repeated, and/or performed in a different order. Accordingly, the specific arrangement of steps shown in FIG. 13 should not be construed as limiting the scope of the embodiments.

First, tension is applied to a sheet of separator material for the battery cell (operation 1302). For example, the tension may be maintained along a length of the sheet as the sheet is unrolled. Next, one or more layers of separator are formed from the sheet by simultaneously cutting both sides of a shape from the sheet orthogonally to a direction of the tension (operation 1304). For example, the two sides may be cut at the same rate inward into the sheet until the sides converge at a common point.

The above-described rechargeable battery cell can generally be used in any type of electronic device. For example, FIG. 14 illustrates a portable electronic device 1400, which includes a processor 1402, a memory 1404 and a display 1408, which are all powered by a battery 1406. Portable electronic device 1400 may correspond to a laptop computer, mobile phone, PDA, tablet computer, portable media player, digital camera, and/or other type of battery-powered electronic device. Battery 1406 may correspond to a battery pack that includes one or more battery cells. Each battery cell may include a set of layers sealed in a pouch, including a cathode with an active coating, a coated separator, an anode with an active coating, and/or a binder coating.

During manufacturing of the battery cell, the layers are stacked, and the binder coating is used to laminate the first set of layers within the first sub-cell by applying pressure and/or temperature to the first set of layers. A second sub-cell containing a second set of layers with different dimensions from the first set of layers may also be obtained, and the first and second sub-cells may be stacked to form a cell stack. Finally, the battery cell may be formed by applying uniform pressure and/or temperature to the cell stack (e.g., using an isostatic-pressing technique and/or a set of stepped plates).

A set of electrodes for the battery cell may also be singulated from a sheet of electrode material and disposed over a first layer of carrier film. A second layer of carrier film may also be disposed over the singulated electrodes. The carrier film may then be formed into a roll to facilitate transport of the electrodes to a subsequent process associated with manufacturing of the battery cell. At the subsequent process, a set of rolls containing singulated layers of the battery cell adhering to one or more layers of carrier film may be unrolled. During unrolling of the rolls, a top layer of carrier film disposed over the singulated layers may be removed to enable use of the singulated layers by the process. The singulated layers may then be used by the process to form a set of sub-cells for the battery cell.

One or more fiducials may also be disposed over the carrier film, electrodes, and/or a fixture for the electrodes and used to align the electrodes during stacking of the electrodes. The fiducials may be disposed using a cutting technique, a pressing technique, and/or an ablation technique and include crosses, points, and/or position holes. Finally, one or more layers of separator may be formed from a sheet of separator material by simultaneously cutting both sides of a shape from the sheet orthogonally to a direction of tension in the sheet.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method for manufacturing a battery cell, comprising:
obtaining a first sub-cell comprising a first set of layers and a second sub-cell comprising a second set of layers with different dimensions from the first set of layers;
stacking the first and second sub-cells to form a cell stack; and
applying uniform pressure to the cell stack to laminate the first and second sets of layers.

2. The method of claim 1, wherein the first and second sets of layers comprise:
a cathode with an active coating;
an anode with an active coating; and
a coated separator comprising a binder coating that laminates the first and second sets of layers upon applying the uniform pressure to the cell stack.

3. The method of claim 2, wherein the coated separator further comprises:
a separator; and
a ceramic coating disposed between the separator and the binder coating.

4. The method of claim 1, wherein the uniform pressure is applied to the cell stack using a set of stepped plates.

5. The method of claim 4, wherein the uniform pressure is further applied using a buffer material disposed over one or more of the stepped plates.

6. The method of claim 1, wherein the uniform pressure is applied to the cell stack using an isostatic-pressing technique.

7. The method of claim 1, wherein the uniform pressure is applied using at least one of a gas, a liquid, and a motor.

8. The method of claim 1, wherein the first and second sub-cells comprise at least one of a mono-cell, a bi-cell, and a half-cell.

9. A battery cell, comprising:
a cell stack comprising:
a first sub-cell comprising a first set of layers; and
a second sub-cell stacked over the first sub-cell, comprising a second set of layers with different dimensions from the first set of layers,
wherein uniform pressure is applied to the cell stack to laminate the first and second sets of layers.

10. The battery cell of claim 9, wherein the first and second sets of layers comprise:
a cathode with an active coating;
an anode with an active coating; and
a coated separator comprising a binder coating that laminates the first and second sets of layers upon applying the uniform pressure to the cell stack.

11. The battery cell of claim 9, wherein the uniform pressure is applied to the cell stack using a set of stepped plates.

12. The battery cell of claim 11, wherein the uniform pressure is further applied using a buffer material disposed over one or more of the stepped plates.

13. The battery cell of claim 9, wherein the uniform pressure is applied to the cell stack using an isostatic-pressing technique.

14. The battery cell of claim 9, wherein the uniform pressure is applied using at least one of a gas, a liquid, and a motor.

15. An apparatus for manufacturing a battery cell, comprising:
a set of stepped plates corresponding to a set of sub-cells stacked to form a cell stack for the battery cell, wherein the set of sub-cells comprises:
a first sub-cell comprising a first set of layers; and
a second sub-cell stacked over the first sub-cell, comprising a second set of layers with different dimensions from the first set of layers; and
a pressing mechanism configured to use the set of stepped plates to apply uniform pressure to the cell stack to laminate the first and second sets of layers.

16. The apparatus of claim 15, further comprising:
a buffer material disposed over one or more of the stepped plates, wherein the pressing mechanism is further configured to use the buffer material to apply the uniform pressure to the cell stack.

17. The apparatus of claim 15, further comprising:
a heat block disposed below the cell stack, wherein the pressing mechanism is further configured to use the heat block to apply the uniform pressure and temperature to the cell stack.

18. The apparatus of claim 15, wherein the first and second sub-cells comprise at least one of a mono-cell, a bi-cell, and a half-cell.

19. The apparatus of claim 15, wherein the uniform pressure is applied using at least one of a gas, a liquid, and a motor.

20. The apparatus of claim 15, wherein the first and second sets of layers comprise:
a cathode with an active coating;
an anode with an active coating; and
a coated separator comprising a binder coating that laminates the first and second sets of layers upon applying the uniform pressure to the cell stack.
